(19) United States
(12) Patent Application Publication
(10) Pub. No.: US 2024/0055781 A1
(43) Pub. Date: Feb. 15, 2024

(54) POWER ELECTRONIC DEVICES WITH BUSBARS AND METHOD FOR THEIR FABRICATION

(71) Applicant: AUDI AG, Ingolstadt (DE)

(72) Inventor: Benjamin SÖHNLE, Ingolstadt (DE)

(21) Appl. No.: 18/447,249

(22) Filed: Aug. 9, 2023

(30) Foreign Application Priority Data
Aug. 10, 2022 (DE) 102022120170.8

(51) Int. Cl. H01R 4/02; H01G 2/00; H01R 43/02

(52) U.S. Cl. CPC H01R 4/029; H01G 2/00; H01R 43/0221

(57) ABSTRACT

The disclosure relates to power electronic devices with busbars and a method for their fabrication. In particular, the disclosure relates to the connection of semiconductor power modules and intermediate circuit capacitor in a commutation cell of an inverter of an electrically powered motor vehicle.

### BACKGROUND

### Technical Field

The disclosure relates to power electronic devices with busbars and a method for their fabrication. In particular, the disclosure relates to the connection of semiconductor power modules and intermediate circuit capacitor in a commutation cell of an inverter of an electrically powered motor vehicle.

### Description of the Related Art

An inverter supplies an e-machine in a hybrid and electric vehicle with power. In the present state of technology, half-bridge modules or three-phase modules are used in so-called hard switching inverters. These are generally connected directly to an intermediate circuit capacitor by busbars. A connection by way of laser beam welding is attractive for this, since the amount of energy applied is manageable and the necessary space requirement is low.

However, the challenge exists that a gap-free contact site needs to be produced over all tolerance positions during laser welding. For this, the busbars are generally bent, which entails risks. For example, stresses may occur in the encapsulation of the capacitor and on the casting compound (molding compound) of the power module due to the uncontrolled bending of the busbars during the joining process. These stresses in the material may lead to crack formations, which can result in a flaking off of material and failure of the components. Likewise, moisture can get into the power module through the crack formation, which over time can also result in damage and failure. Moreover, a costly tool is needed for the joining process, and the process capability is not assured over large production lot numbers.

DE 10 2020 109 500 A1 relates to a method for connecting at least two electronic components, each of them comprising a component body and at least one contact tab protruding from the component body. The method involves the steps: providing of the at least two electronic components, arranging the components so that at least a first contact tab of a first one of the components lies overlapping against a second contact tab of a second one of the components, the second contact tab standing at least with one contact tab segment at an angle greater than 0° and less than 90° relative to the first contact tab, applying a first force to the first component so that a contact surface between the first contact tab and the second contact tab segment is enlarged by a deformation of the second contact tab, applying a second force at least to one segment of the first contact tab so that the contact surface between the first contact tab and the second contact tab is enlarged by a deformation of the first contact tab, and securing the contact tabs against each other.

JP 2012 010 426 A describes a power conversion device. The power conversion device is supplied with current from a current source and comprises a capacitor module having at least one capacitor element; a semiconductor module having at least two switching elements, which are switched in series in the upper part and in the lower part and convert current supplied from the current source; and a heat dissipator, which cools the semiconductor module. The power conversion device moreover comprises busbars, which integrally connect first conductive plates, connected to a terminal of the capacitor element, and second conductive plates, connected to terminals of a plurality of semiconductor modules.

WO 2020/126 316 A1 discloses a low-inductance connection device for connecting a semiconductor module to an intermediate circuit capacitor, comprising at least one first contact region and one second contact region, opposite in polarity to the first contact region, which are adapted to contact the semiconductor module, at least one third contact region having the same polarity as the first contact region and a fourth contact region having the opposite polarity of the third contact region, which are adapted to contact the intermediate circuit capacitor, at least one first connection region, which is adapted to connect the first contact region and the third contact region to each other, at least one second connection region, which is adapted to connect the second contact region and the fourth contact region to each other, while the first connection region and the second connection region are each configured as separate planar busbars.

Embodiments of the disclosure provide power electronic devices having busbars and a method for their fabrication, which prevents the mechanical stresses occurring during the assembly of the device and the resulting crack formations in the components of the device and which do not require any special tool for the joining process of the components.

### BRIEF SUMMARY

One embodiment of the disclosure is a power electronic device, comprising a first power electronics component and a second power electronics component, which are connected to each other across at least one busbar which is formed by a first contact tab arranged on the first power electronic component and a second contact tab arranged on the second power electronic component. According to the disclosure, at least one of the two contact tabs, the first contact tab and/or the second contact tab, is designed as a spring contact and an end region of the spring contact presses against the other respective contact tab when forming the at least one busbar and forms a line contact between the first contact tab and the second corresponding contact tab. The end region of the spring contact is curved convex with respect to the other respective contact tab.

According to the disclosure, for the electrical connection of two power electronic components, each comprising at least one contact tab, when forming a busbar from two mutually coordinated contact tabs of the two components at least one of the participating contact tabs is configured as a spring contact, having a convex curved end region opposite the other contact tab. The spring contact allows a minimization of the stresses for the busbar geometry and an optimized joining process of the busbars. The spring contact can automatically balance out the tolerances of the component dimensions without an additional tool thanks to an overlapping during the component fixation. Thanks to the convex curved end region of the spring contact, a line contact between the two joining partners is formed reliably over all tolerance levels.

The end region of the spring contact has a convex curvature opposite the other contact tab involved in the forming of the busbar. In one embodiment, the end region of the spring contact has the shape of a circular line. In another embodiment, the end region of the spring contact has an elliptical curvature. In yet another embodiment, the end region of the spring contact has a sinusoidal curvature.

In another embodiment, the contact spring has a marking on the inside of the convex curvature of the end region in the region of the line contact. In one special embodiment, the marking is a notch. The notch can be made, for example, in the punching process of the contact spring. Thanks to the marking, the region at which the two contact tabs are supposed to be connected is made more noticeable, e.g., for an image recognition in a laser welding process for connecting the contact tabs.

In one embodiment of the power electronic device, the first contact tab and the second contact tab are connected to each other permanently along the line contact. In another embodiment, the first contact tab and the second contact tab comprise a weld connection along the line contact. In another embodiment, the first contact tab and the second contact tab comprise a solder connection along the line contact. In yet another embodiment, the first contact tab and the second contact tab comprise an electrically conductive glue connection along the line contact.

In another embodiment, the power electronic device comprises a commutation cell of an inverter. In another embodiment, the first power electronic component comprises a power box with three half-bridges and the second power electronic component comprises at least one intermediate circuit capacitor. In theory, however, the power electronic device can comprise any given power electronic circuits and components.

Another embodiment of the disclosure is a method for connecting a first electronic component and a second electronic component across at least one busbar. The first electronic component and the second electronic component each comprise a component body and at least one contact tab protruding from the component body, being adapted to make contact with each other when the first electronic component and the second electronic component are connected to each other. At least one of the two contact tabs, the first contact tab and/or the second contact tab, is designed as a spring contact and an end region of the spring contact is curved convex with respect to the other respective contact tab. In one embodiment, the end region of the spring contact has the shape of a circular line.

In the method for connecting a first electronic component and a second electronic component across at least one busbar, at least one busbar is formed from the contact tabs of the two components. For this, the first electronic component and the second electronic component are placed in an end position, in which the contact tab of the first electronic component and the contact tab of the second electronic component are touching and form a line contact between the contact tabs. Then, the contact tab of the first electronic component and the contact tab of the second electronic component are connected to each other permanently along the line contact.

In one embodiment of the method, the contact tab of the first electronic component and the contact tab of the second electronic component are welded together along the line contact. In another embodiment of the method, the contact tabs are welded together by way of a laser beam. In another embodiment of the method, the contact tab of the first electronic component and the contact tab of the second electronic component are soldered together along the line contact. In yet another embodiment of the method, the contact tab of the first electronic component and the contact tab of the second electronic component are glued together along the line contact by way of a conductive glue.

The solution according to the disclosure makes it possible to produce in reliable manner a line contact between the two pieces being joined over all tolerance levels of the modules being electrically connected, without requiring a special tool for the joining and welding process. Tolerances in the dimensions of the modules are automatically balanced out during the component fixation. The position of the line contact can be reliably identified and welded. Further benefits and configurations of the disclosure will emerge from the description and the enclosed drawings.

Of course, the features mentioned above can be used not only in the particular indicated combination, but also in other combinations or standing alone, without leaving the scope of the present disclosure.

### BRIEF DESCRIPTION OF THE SEVERAL VIEWS OF THE DRAWINGS

The disclosure is represented schematically with the aid of one embodiment in the drawings and shall be further described with reference to the drawings.

FIG. 1 shows a schematic perspective representation of a device according to the disclosure;

FIG. 2 shows a side view of the device shown in FIG. 1.

### DETAILED DESCRIPTION

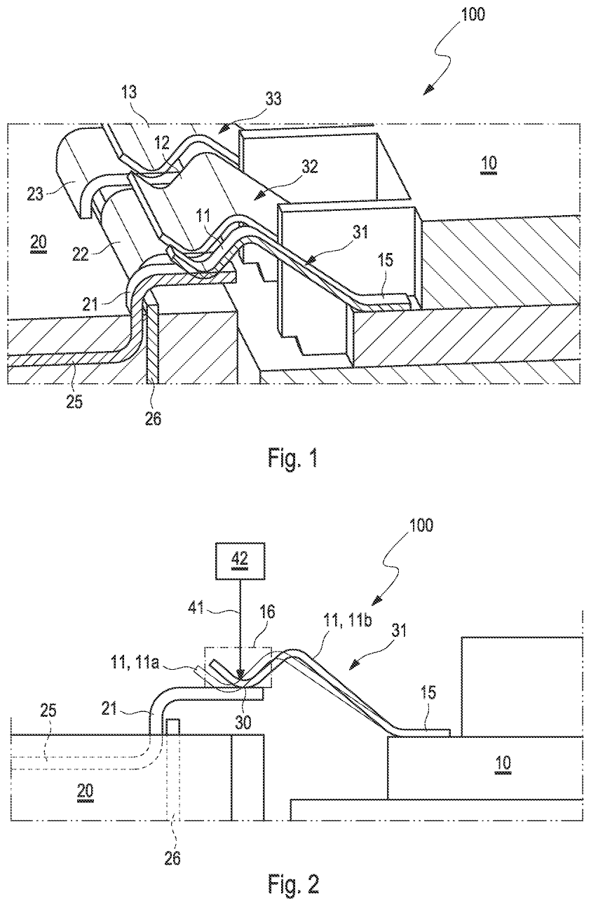

FIG. 1 is a schematic representation of a device 100 according to the disclosure. The device 100 shown is the commutation cell of an inverter. A portion of the device 100 with a power box 10 and an intermediate circuit capacitor 20 is shown. In order to make the electrical connections, the power box 10 has contact springs 11, 12, 13, and corresponding contact tabs 21, 22, 23 are provided on the intermediate circuit capacitor 20, which are hooked up to electrical lines 25, 26 leading into the interior of the intermediate circuit capacitor 20. Through the contact springs 11, 12, 13 and the corresponding contact tabs 21, 22, 23, electrically conductive connections 31, 32, 33 are produced between the power box 10 and the intermediate circuit capacitor 20. FIG. 2 shows a side view of the device 100 according to the disclosure.

The contact springs 11, 12, 13 are connected on one side to the half-bridges of the power box 10 (e.g., by way of laser welding). In the drawings, the connection point 15 of the contact spring 11 is shown; the connection points of the contact springs 12 and 13 are not visible in the drawing. The connection point 15 can be situated on the surface of the power electronic component 10 or in the interior of the component 10 and it can be encased in a casting compound, for example.

The contact springs 11, 12, 13 are designed such that the produce in reliable manner over all tolerance levels a line contact 30 between the two joining partners (contact spring 11 and contact tab 21, contact spring 12 and contact tab 22, as well as contact spring 13 and contact tab 23). For this, no additional joining tool is required. As illustrated in FIG. 2 on the example of the contact spring 11, the contact spring 11 is deformed from its construction position 11a to an end position 11b in order to balance out the component tolerances and produce a line contact 30 between the contact spring 11 and the contact tab 21.

As indicated in FIG. 2, a durable connection can be created by a laser beam 41 generated by a laser 42 between the contact spring 11 and the contact tab 21 along the line contact 30, so that a busbar 31 is formed. Thanks to the configuration of the end region 16 of the contact spring 11 situated on top during the welding as a circular arc, the position of the line contact 30 can always be identified and reliably welded. The region to be welded can be additionally made more recognizable, for example, by way of a notch (not shown), which is made in the punching process of the contact spring 11, 12, 13, for example, for an image recognition in a laser welding process.

German patent application no. 102022120170.8, filed Aug. 10, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A power electronic device, comprising:
a first power electronics component;
a second power electronics component; and
at least one busbar that connects the first power electronics component and the second power electronics component to each other,
wherein the at least one busbar includes a first contact tab arranged on the first power electronic component and a second contact tab arranged on the second power electronic component,
wherein a first one of the first contact tab and the second contact tab includes a spring contact, and
wherein an end region of the spring contact presses against a second one of the first contact tab and the second contact tab and forms a line contact between the first contact tab and the second contact tab, and
wherein the end region of the spring contact is curved convex with respect to the second one of the first contact tab and the second contact tab.

2. The power electronic device according to claim 1, wherein the end region of the spring contact has a shape of a circular line.

3. The power electronic device according to claim 1, the first contact tab and the second contact tab are connected to each other permanently along the line contact.

4. The power electronic device according to claim 3, the first contact tab and the second contact tab include a weld connection along the line contact.

5. The power electronic device according to claim 3, wherein the first contact tab and the second contact tab include a solder connection along the line contact.

6. The power electronic device according to claim 3, wherein the first contact tab and the second contact tab include an electrically conductive glue connection along the line contact.

7. The power electronic device according to claim 1, further comprising a commutation cell of an inverter.

8. The power electronic device according to claim 7, wherein the first power electronic component includes a power box with three half-bridges and the second power electronic component includes at least one intermediate circuit capacitor.

9. A method for connecting a first electronic component and a second electronic component across at least one busbar, wherein the first electronic component and the second electronic component each include a component body and at least one contact tab protruding from the component body, and wherein the at least one contact tab protruding from the component body of the first electronic component and the at least one contact tab protruding from the component body of the second electronic component make contact with each other when the first electronic component and the second electronic component are connected, and wherein a first one of the contact tab of the first electronic component and the contact tab of the second electronic component includes a spring contact and an end region of the spring contact is curved convex with respect to the a second one of the contact tab of the first electronic component and the contact tab of the second electronic component, the method comprising:
placing the first electronic component and the second electronic component in an end position, in which the contact tab of the first electronic component and the contact tab of the second electronic component are touching and a line contact is formed between the contact tab of the first electronic component and the contact tab of the second electronic component, and then
connecting the contact tab of the first electronic component and the contact tab of the second electronic component to each other permanently along the line contact.

10. The method according to claim 9, wherein the connecting includes welding the contact tab of the first electronic component and the contact tab of the second electronic component to each other along the line contact by a laser beam.
